(19) United States
(12) Patent Application Publication
(10) Pub. No.: US 2003/0036844 A1
(43) Pub. Date: Feb. 20, 2003

(54) System and method for bookmarking a route

(76) Inventor: Senaka Balasuriya, Westmont, IL (US)

Correspondence Address: MOTOROLA INC, 600 NORTH US HIGHWAY 45, LIBERTYVILLE, IL, 60048-5343, US

(21) Appl. No.: 09/930,720

(22) Filed: Aug. 15, 2001

(51) Int. Cl. G01C 21/26; G01C 21/28

(52) U.S. Cl. 701/201; 701/211

(57) ABSTRACT

A method of identifying a route is provided. A route is described, for example by inputting a first location and a second location. A route-identifier is defined for the route, wherein the route-identifier identifies a route between the first location, which may for example be the starting location, and the second location, which may for example be the ending location. The route identifier is stored. The route identifier may be used to retrieve the route information. Methods and programs for identifying a route are also provided.

### FIELD OF THE INVENTION

The present invention relates generally to communication systems. In particular, the present invention provides a method and system for storing a relationship between two or more points (such as a route between the two points) and obtaining information about that relationship.

### BACKGROUND OF THE INVENTION

In a typical communication system, such as the Internet, it is possible to visit a location within the system, store the location (e.g. “bookmark” the location) and then return to that location at a later time. For example, Microsoft™ Internet Explorer allows a user to access a given web site, bookmark the site and then return to the same site at a later time. Once bookmarked, the user may easily access the site, usually by selecting the bookmark from a stored list of bookmarks (in Internet Explorer this list is typically called “Favorites”.)

In a typical communication system, it is also possible to enter location data for more than one location, store the data and then access the data at a later time. For example, Yahoo™ allows a user to enter one or more street addresses (such as a pair of cross-streets) on a web page, store the entered data (e.g. “bookmark” the data) and then access the data at a later time. Once bookmarked, the user may easily access the data, usually by selecting the bookmark from a stored list of bookmarks (in Yahoo™, this list is typically called “My Locations”).

In a wireless communication system, it may also be possible to obtain immediately pertinent information in relation to bookmarked data. For example, a user may obtain information about a stored street address such as directions from the address or current weather conditions at the address.

However, typical communication systems have limited capabilities. It would be desirable therefore to provide a method additional capabilities for a communications system.

### BRIEF DESCRIPTION OF THE DRAWINGS

FIG. 1 is a block diagram illustrating a communication system in which the invention can be implemented;

FIG. 2 is a flow chart illustrating a routine for storing a relationship between two points;

FIG. 3 is a flow chart illustrating a routine for accessing a relationship stored using the embodiment of FIG. 2;

FIG. 4 is a flow chart illustrating another routine for accessing a relationship stored using the embodiment of FIG. 2;

FIG. 4 is a flow chart illustrating another routine for accessing a relationship stored using the embodiment of FIG. 2;

FIG. 5 is a flow chart illustrating another routine for accessing a relationship stored using the embodiment of FIG. 2; and

FIG. 6 is an exemplary block diagram illustrating another embodiment of a communication system.

### DETAILED DESCRIPTION OF THE PRESENTLY PREFERRED EMBODIMENTS

A system and method permit saving of a route between an originating location and a destination. The route may be identified by a first location and a second location. A route-identifier is used to identify a route between the first location and the second location, and route identifier is stored. The route identifier is used to retrieve the route. Typical communications systems do not allow the ability to select more than one location, save the relationship between the selected locations and then return to the relationship at a later time. Typical communications systems also do not allow the ability to obtain pertinent information about the relationship at a later time. In particular, a typical communication system does not allow selection of a first location and one or more additional location to create a route that may then be bookmarked.

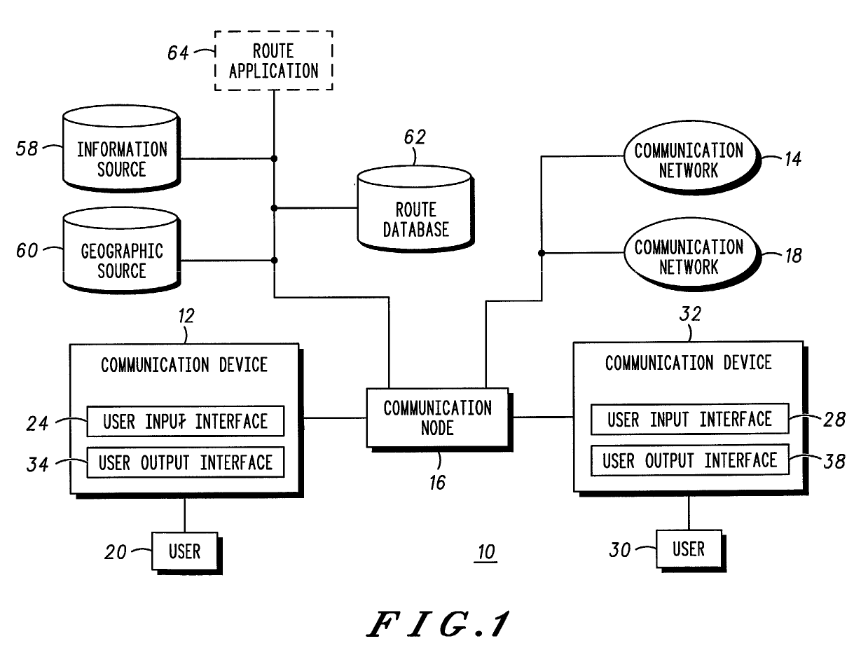

FIG. 1 is a block diagram illustrating one embodiment of a communication system 10. The communication system 10 generally includes one or more network access devices or communication devices 12, 32, communication networks 14,18 and a communication node 16. The communication system 10 may also include one or more of each of the following: route application 64, route database 62, geographic source 60 and information source 58.

As further described below, the communication system 10 may provide various services and capabilities to cellular users, wire-line telephone users, paging users, satellite users, mobile or portable telephone users, trunked users, computer network users (e.g., Internet or Intranet users), wireless data users, branch office users, cable users and the like. Communication system 10 may also accurately locate communication device 12, 32 and/or its associated user 20, 30 in order to provide location-relevant services to the user 20, 30 via device 12, 32. Communication system 10 may also accurately locate any relevant location in order to provide services to the user 20, 30 via device 12, 32. Communication system 10 or any of its components may be operated by any entity, including, without limitation, a government agency, a commercial entity, or any other appropriate entity.

In one embodiment of the invention, communication system 10 also includes a route application 64. Route application 64 may include one or more programs or other applications for creating and otherwise processing information about two or more points, such as geographic points, or information about routes between two or more points. Route application 64 may comprise computer readable/processable program code. Such route information may be information input by user 20, 30 via device 12, 32. Route application 64 may also process information to be sent to or stored in route database 62. Alternatively, route information processed by route application 64 may be information provided by communication node 16 or forwarded by communication node 16 from communication networks 14,18. Route information processed by route application 64 may also be provided by information sources such as route database 62 or geographic source 60. Route application 64 may interact with user 20, 30 via device 12, 32. Route application 64 may reside on or be in communication with communication node 16 or communication device 12, 32.

Route application 64 may process information from one or more information sources. One such information source is route database 62. In one embodiment of the present invention, route database 62 stores geographic locations in the form of routes between two or more geographic locations. For example, a user may send a geographic location such as the route between two or more street addresses (e.g. “Route from Home to Work”) to be stored in route database 62. The user may input the location to be stored from a communication device 12, 32 via communication node 16.

Route database 62 may contain an identifier and associated route information. For example, route database 62 may contain the identifier “HOME/WORK” and the route information “starting point: 3200 N. Clark Street, Chicago, Ill. 60657 and endpoint point: 1603 Orrington Avenue, Evanston, Ill. 60201” as one entry. The data stored in route database 62 may also take other forms including, but not limited to, latitude/longitude, points of interest or intersections. For example, the route and identifier above may also take the format “HOME/WORK” and associated route information “first endpoint: Belmont and Clark, Chicago and second endpoint: Orrington and Davis, Evanston, Ill.”. The data stored in route database 62 may also store information in a combination of forms. For example, the route and identifier above may also take the form “HOME/WORK” and associated route information “endpoint 1: Belmont and Clark, Chicago and endpoint 2: Bank One Building, Evanston, Ill.”

Route application 64 may also process information from one or more information sources such as geographic source 60. In one embodiment of the present invention, geographic source 60 stores authentic (“real”) geographic locations. Alternatively, this geographic source 60 authenticates, verifies or otherwise processes information about to be stored or already stored in route database 62. For example, a user may send a route such as those described above to be stored in route database 62. Before the route is accepted to be stored, communication system 10 authenticates or otherwise processes the address using geographic source 60. For example, geographic source 60 may be a GIS engine that authenticates each of the addresses in a given route as existing addresses. In one embodiment of the invention, geographic source 60 may authenticate that the route is accurate, e.g. the user desires to store the route between his home and a hotel in Seattle but the geographic source 60 indicates the hotel is no longer at the location entered by the user. In another embodiment, geographic source 60 may complete or correct the location input by the user, verifying that the address is authentic and unambiguous and completing the address with the zip code or zip+4. For example, the user says “endpoint 1 is Belmont and Clarke, spelled C-L-A-R-K-E, Chicago, Ill. and endpoint 2 is the Bank One Building, Evanston, Ill.” and the geographic source provides the corrected information that the first endpoint is “Belmont and Clark, spelled C-L-A-R-K Chicago, Ill. 60657” and the completed information that the second endpoint is “Bank One Building, Evanston, Ill. 60201.” The user may input the route to be stored from a communication device 12, 32 via communication node 16.

In one embodiment, geographic source 60 may comprise authentic (“real”) cellular and sector identification information. Geographic source 60 may also include maps relating to such cellular and sector identification information. Geographic source 60 may also include geographical and non-geographical information about countries, states/provinces, counties/parishes, metropolitan areas, cities, ZIP codes, area codes, landmarks, points of interest, subway and train stations, airports, streets, gas stations, Automated Teller Machines (ATMs), hospitals, police stations, restaurants, etc. In one embodiment, geographic source 60 may comprise a virtual map of a given area, complete with a listing of all geographical entities on the map, such as a listing of all streets within Chicago, Illinois, for example. Geographic source 60 may also include such information as specific names and addresses (e.g. a list of hospital names and their addresses) or a more general address listing (e.g. an electronic “yellow pages”).

Location parameters that may be corrected, completed or otherwise processed using information from geographic source 60 include, but are not limited to: lists of streets within a city; lists of streets within a cell or sector; lists of streets within a state; lists of street names and numbers; zip code lists; lists of street intersections; lists of landmarks in a given city, state, cell or sector; lists of places of interests in a given city, state, cell or sector; lists of banks in a given city, state, cell or sector; lists of restaurants in a given city, state, cell or sector; lists of hotels in a given city, state, cell or sector; lists of post offices in a given city, state, cell or sector; lists of businesses of a given type in a given city, state, cell or sector, etc.

Route application 64 may also process information from one or more other information sources 58. In one embodiment of the present invention, information source 58 stores information that may be relevant to a given route. Such information includes, but is not limited to, traffic conditions, weather conditions, upcoming conditions along the way (e.g., toll booths coming up on the route), relevant locations on the route (e.g., restaurants along the route, banks along the route.) For example, a user may send a route such as those described above to be stored in route database 62. Before the route is accepted to be stored or after the route has been stored, communication system 10 may provide information about the route using information source 58. For example, information source 58 may provide up-to-date weather conditions for the area encompassing user's “HOME/WORK” route or, if the route covers a large area, weather conditions for portions of the route. Alternatively, information source 58 may provide traffic conditions at points along the route. Alternatively, information source 58 may provide information about a third point on the route, e.g., the location of a toll booth on the route, the McDonalds™ nearest to the first endpoint of the route, or the name of the bank closest to the second endpoint of the route. Alternatively, if the user is currently on the route, information source may provide information about the user's location on the route, e.g. weather conditions for the user's current location on the route.

Information source 58 may be, for example, a web site on the Internet in communication with or accessed by communication system 10 or a component of system 10. Information source 58 may also be a service, such as a weather service in communication with or accessed by communication system 10 or a component of system 10, e.g. the National Weather Service.

The communication device 12, 32 of the communication system 10 may be utilized by end user 20, 30 to access and/or connect with the communication node 16. Communication device 12, 32 may also be used by end user 20, 30 to access and/or connect with route application 64. The communication device 12, 32 can include, but is not limited to, wireline telephones, mobile telephones, paging units, radio units, wireless data devices, Web telephones, portable or wireless telephones, personal information managers (PIMs), personal digital assistants (PDAs), personal computers (PCs), network televisions (TVs), Internet TVs, Internet telephones, portable wireless devices (i.e., two-way pagers), security systems (both mobile and premises-based), workstations or any other suitable communication devices.

Regardless of its specific form, the communication devices 12, 32 have user-input interfaces 24, 28 and/or user-output interfaces 34, 38. Alternatively, the user-input interfaces 24, 28 and/or user-output interfaces 34, 38 may work in conjunction with the communication device 12, 32 without actually residing on the device 12, 32.

The user-input interfaces 24, 28 may receive input from the users 20, 30 and the user-output interfaces 34, 38 may provide output to the users 20, 30. The user-input interfaces 24, 28 can include, but are not limited to, an electroacoustic transducer, such as, for example, a microphone to receive voice and other audible input from the users 20, 30 a keypad or a keyboard to receive key strokes from the users 20, 30 a touchpad or touchscreen to receive touch input from the users 20, 30 a handwriting recognition interface to receive handwritten input from users 20, 30 and a pointing device such as a mouse or a trackball to receive point and click inputs from the users 20, 30. In one embodiment of the present invention, user-input interface 24, 28 may be a modified car dashboard allowing input from users 20, 30.

The user-output interfaces 34, 38 of the communication devices 12, 32 can include, but are not limited to, an electroacoustic transducer such as, for example, a speaker to provide voice and other audible output to the users 20, 30, and a visual display device such as a liquid crystal display or a cathode ray tube to provide graphical and/or textual information to the users 20, 30. In one embodiment of the present invention, user-output interface 34, 38 may be a modified car dashboard providing output to users 20, 30.

Each of the communication devices 12, 32 may include more than one user-input interface 24, 28 or more than one user-output interface 34, 38. Moreover, the user may use one or more user-input interfaces 24, 28 or user-output interfaces 34, 38 simultaneously. For example, a wireless telephone may have a microphone, a telephone keypad, a speaker, and a visual display device.

In one embodiment of the invention, an input interface 24, 28 may also reside on the communication node 16. Output interface 34, 38 may also reside on the communication node 16. Alternatively, input interface 24, 28 may reside on the communication node 16 while output interface 34, 38 resides on the device 12, 32. Alternatively, input interface 24, 28 may reside on the device 12, 32 while output interface 34, 38 resides on communication node 16.

The communication device 12, 32 may also communicate with communication networks 14, 18 via the communication node 16. The communication network 14 can interface with the communication device 12, 32 through wireline or wireless networks or systems (i.e., telephone or televisions systems, Integrated Services Digital Network (ISDN) systems, coaxial lines, computer networks, digital end user lines, private networks, wireless local loop systems, etc.). Information sources 58 may be accessible to, available on or in communication with communication networks 14, 18.

The communication networks 14, 18 of the communication system 10 can include, but are not limited to, intranets, extranets, the Internet, a Local Area Network (LAN), a telephone network, (e.g., a Public Switched Telephone Network (PSTN), private telephone networks, etc.), a cellular network, satellite networks, a personal communication system, a TV network (e.g., a cable TV system), local, regional, national or global paging networks, an email system, a wireless data network (e.g., satellite data or local wireless data networks), a wireless LAN, a wireless local loop/distribution system (e.g., LMDS, MMDS or Code Division Multiple Access (CDMA) based system), a Voice Over Internet Protocol (VOIP) network, or any other suitable network. The communication networks 14, 18 can also include a wide area network (WAN), such as, for example, the Internet, the World Wide Web (WWW) or any other similar online service. It will be recognized that the communication networks 14, 18 may have portions in common, may comprise two separate networks, or may be the same network.

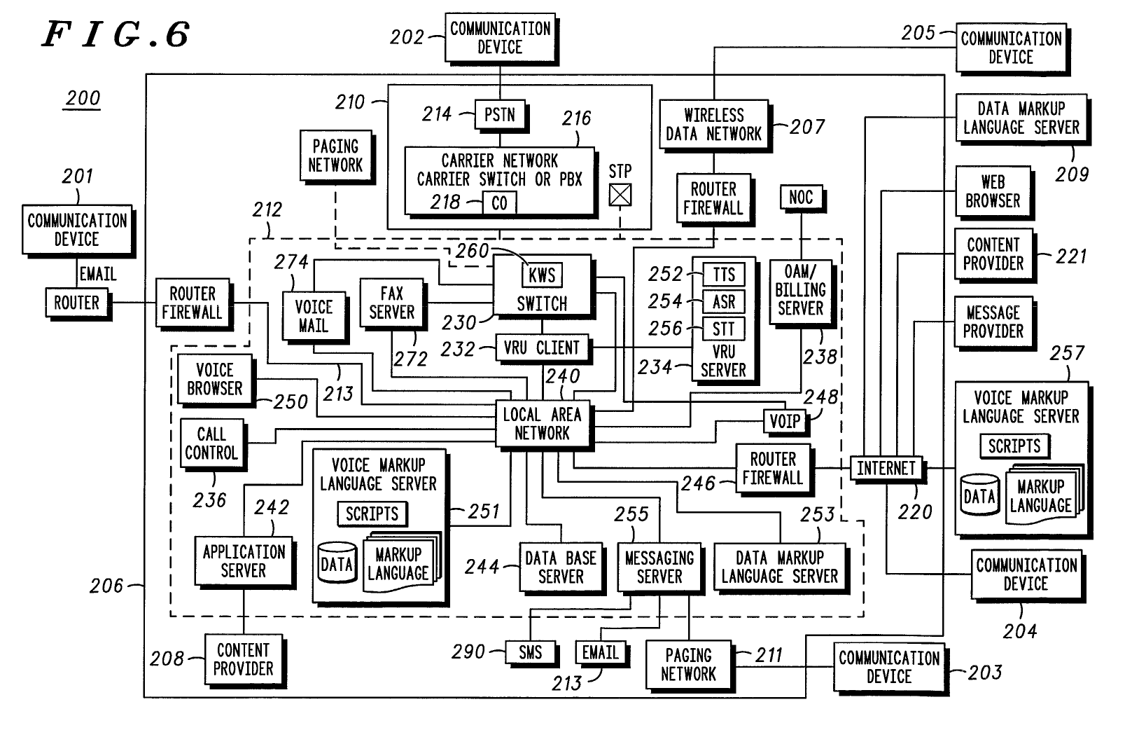

The communication node 16 of the communication system 10 can include, but is not limited to, an interactive voice response node, a server computer, the MIX™ platform and the Myosphere™ Service provided by Motorola, Inc. of Schaumburg, Ill. (as further described with reference to FIG. 6), or other suitable system. It will be recognized that the communication node 16 may be integrated within or may be remote from the communication networks 14, 18.

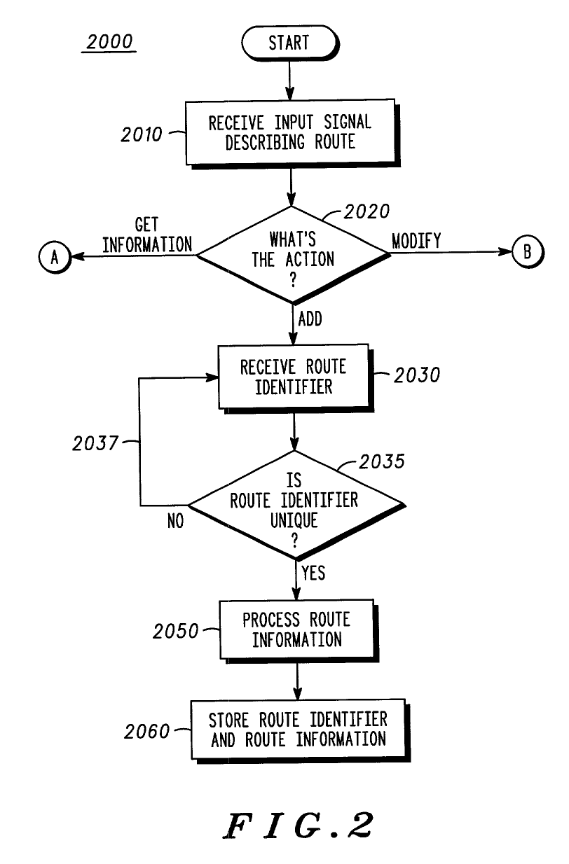

FIG. 2 illustrates one embodiment of a routine for storing a relationship between two points in accordance with the present invention at 2000. The routine of FIG. 2 may be used, for example, when a user 20, 30 first attempts to store a relationship between two or more points, such as a travel route between two locations.

At block 2010 an input signal is received describing the route. This input signal may take the form of data describing a starting point and an endpoint. For example, the user may say “Identify ‘Belmont and Clark, Chicago, Ill.’ as the start point and ‘Davis and Orrington, Evanston, Illinois’ as the endpoint of a route called “HOME/WORK”. The input signal may also take the form of data describing versions of the route (e.g. fastest version, scenic version, version of route using the shortest distance, version without any highways, version of route with no tolls). For example, the user may say “Identify the route between 3200 North Clark in Chicago, Ill. and 1600 Orrington Avenue in Evanston, Ill. which uses Lake Shore Drive as ‘HOME/WORK-FASTEST”.

At Block 2020, the action to be taken determines which routine may be used in accordance with the present invention. For example, FIG. 2 shows three possible actions: GET INFORMATION, ADD and MODIFY. These three actions serve as examples and do not limit the actions that may be taken in accordance with the present invention.

In the case of adding a route to be stored, at block 2030 a route identifier may be received. This identifier may be included in the initial input signal transmitted at Blocks 2010. Alternatively, the route identifier may be sent separately.

At Block 2035 the uniqueness of the route identifier is evaluated. In one embodiment, this evaluation is performed by route application 64. Alternatively, this evaluation is performed by node 16 or by route application 64 on node 16. In one embodiment this evaluation includes a determination by route application 64 of whether or not the route identifier is already in use. If the route identifier is already in use (as seen at 2037) another route identifier may be received as illustrated at 2030. If the route identifier is already in use, the communication node 16 may indicate to user 20, 30 that a new route identifier should be chosen.

In one embodiment, the user is prompted to confirm the route identifier received at Block 2030. In another embodiment the identifier may be provided to the user and then confirmed. Alternatively, the route identifier may be generated by route application 64, by communication node 16 or another party, such as a system administrator.

If the route identifier received at Block 2030 is not currently in use or is otherwise determined to be unique, the route associated with the route identifier may be processed (Block 2050). For example, the points of the route may be processed (e.g., converted to an appropriate format such as a latitude and longitude). Such processing may also include encrypting the route identifier and associated route or any other suitable processing. Such processing may also include adding further information to the route identifier and its associated route. For example, processing may include completing geographic information related to the points of the route, e.g. adding a zip code or a zip+4 to the addresses associated with one or more points of the route. As another example, processing may include adding a route type describing the associated route (e.g. fastest route, shortest route, scenic route).

Then at block 2060, the route identifier and its associated route may be stored in any suitable manner, such as, for example, in a database in communication with communication node 16 or device 12, 32.

During the time the route and route identifier are being processed, a signal may be sent to the user, for example via the browser of device 12, 32. This signal may contain one or more commands to the browser of device 12, 32. In one embodiment of the invention, the signal may be sent via node 16. Alternatively, the signal may be sent directly from route application 64. In one embodiment of the invention, device 12, 32 may tell the user “Route ‘HOME/WORK’ being stored” during this time period.

Once the route identifier and associated route have been stored, the route application 64 may send a response to the user 20, 30. This response may contain one or more commands. For example, device 12, 32 may say “Route ‘HOME/WORK’ has been stored”. Device 12, 32 may also prompt “Store route ‘HOME/WORK’ now?” or may ask additional information from the user, such as “Is this the fastest route between Home and Work?”

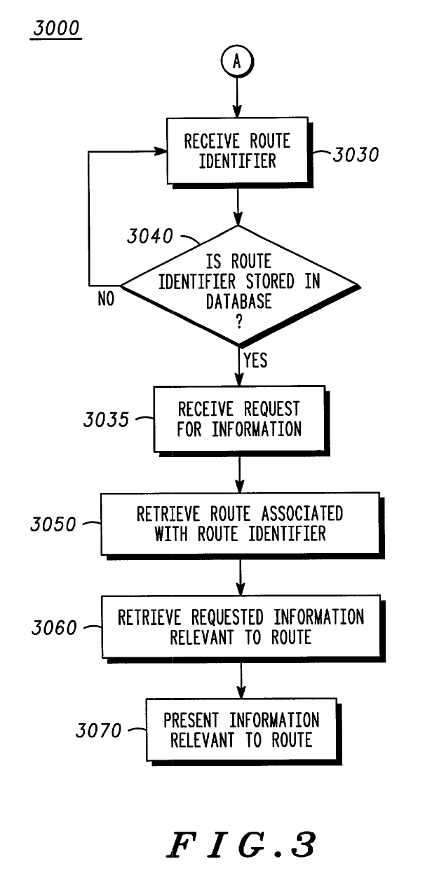

FIG. 3 illustrates one embodiment of a routine for retrieving information relevant to a route in accordance with the present invention at 3000. The routine of FIG. 3 may begin with the input signal being received as illustrated at Block 2010 of FIG. 2. Alternatively, the routine of FIG. 3 may begin after a route identifier has already been stored as illustrated at block 2060.

At Block 3030 of FIG. 3, the route identifier may be received. The identifier may be, for example, a suitable route identifier as described above. At block 3035, a request for information about the route identified by the route identifier may also be received. For example, the user may request “Tell me current traffic conditions on route “HOME/WORK”. The request may also further describe the version of the route identified by the route identifier. For example, the user may say “Access fastest route for “HOME/WORK”. In FIG. 3, the steps shown at 3030 and 3035 may occur in any suitable order.

Then, at Block 3040, it may be determined if the route identifier has been stored within system 100. For example, it may be determined if the route identifier has been stored in route database 62. Such a route identifier may have been stored, for example, as indicated at Block 2060 of FIG. 2. If the route identifier has been stored, the information associated with the route identifier may then be retrieved at block 3050. Alternatively, if the route identifier has not previously been stored, the routine may return to 3030 as shown in FIG. 3. Another identifier may then be received.

Once the route information has been retrieved at block 3050, as seen at block 3060, information relevant to the route may be retrieved. This route-relevant information may be stored in any suitable location and may be accessed by any suitable component of system 100. For example, the route-relevant information may be stored in information source 58 or geographic source 60. In one example, information about the current traffic conditions may be retrieved from a traffic database or a news service. The route-relevant information may also be dynamically created information rather than accessed information. For example, the route-relevant information may be a calculation of the shortest version of the route identified by the route identifier. Alternatively, the information relevant to the route may be a combination of accessed and dynamically created information. For example, the information provided may be traffic conditions for various roads that can be used to complete the route identified by the route identifier.

At block 3070, the retrieved information may be presented. For example, the user may hear “There is an accident at 5600 North Clark on route ‘HOME/WORK’.” The user may also hear “There is an accident on the shortest distance route of ‘HOME/WORK’. Would you like to determine an alternative ‘HOME/WORK’ route?”

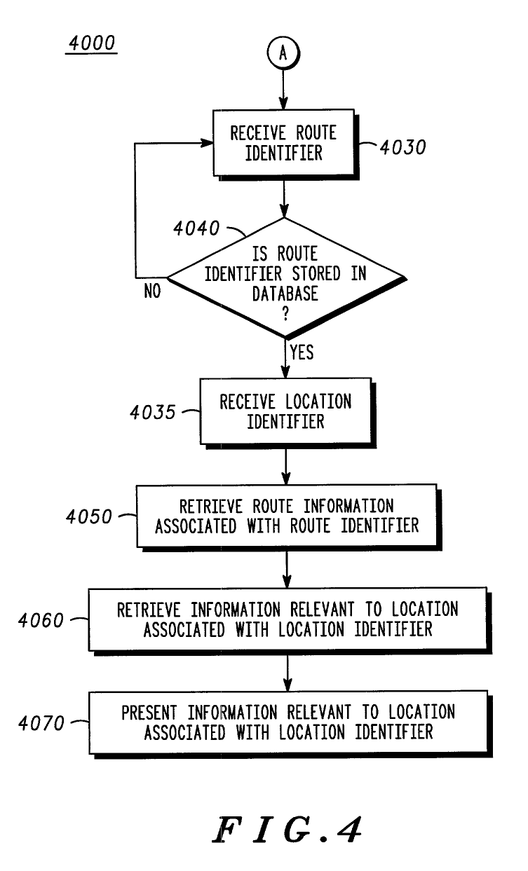

FIG. 4 illustrates another embodiment of a routine for retrieving information relevant to a route in accordance with the present invention at 4000. The routine of FIG. 4 may begin with the input signal being received as illustrated at Block 2010 of FIG. 2. Alternatively, the routine of FIG. 4 may begin after a route identifier has already been stored as illustrated at block 2060.

At Block 4030 of FIG. 4, the route identifier may be received. The identifier may be, for example, a suitable route identifier as described above. At block 4035, a location identifier may also be received. This location identifier may be any suitable identifier that describes a location along the route identifier by the route identifier. In one embodiment of the invention, the location identifier describes a third point between the starting point and ending point of the route identified by the route identifier. For example, the location identifier may identify where a mobile user is currently located on the route “HOME/WORK”, e.g. “My location is about 3 miles from the starting point of route “HOME/WORK”. This location identifier may be input by the user 20, 30. The location identifier may also be input by another entity, such as, for example, a global positioning device on the user's car. In FIG. 4, the steps shown at 4030 and 4035 may occur in any suitable order.

Then, at Block 4040, it may be determined if the route identifier has been stored within system 100. For example, it may be determined if the route identifier has been stored in route database 62. Such a route identifier may have been stored, for example, as indicated at Block 2060 of FIG. 2. If the route identifier has been stored, the information associated with the route identifier may then be retrieved at block 4050. Alternatively, if the route identifier has not previously been stored, the routine may return to 4030 as shown in FIG. 4. Another identifier may then be received.

Once the route information has been retrieved at block 4050, as seen at block 4060, information relevant to the location identified by the location identifier may be retrieved. This location-relevant information may be stored in any suitable location and may be accessed by any suitable component of system 100. For example, the location-relevant information may be stored in information source 58 or geographic source 60. In one embodiment, information about the current traffic conditions may be retrieved from a traffic database or a news service. For example, the traffic conditions for a point five miles from the ending point of route “HOME/WORK” may be provided to the user. In another embodiment, the location of other objects in relation to the location identified by the location identifier may be provided in the context of the route identified by the route identifier. For example, the location of the toll booth nearest to the mobile user's current location may be provided in the context of the route the user is on.

At block 4070, the retrieved information may be presented. For example, the user may hear “Traffic is clear from your current location all the way to the HOME point of route ‘HOME/WORK’.” The user may also hear “The nearest toll booth to your current location is another two blocks along the route ‘HOME/WORK’.”

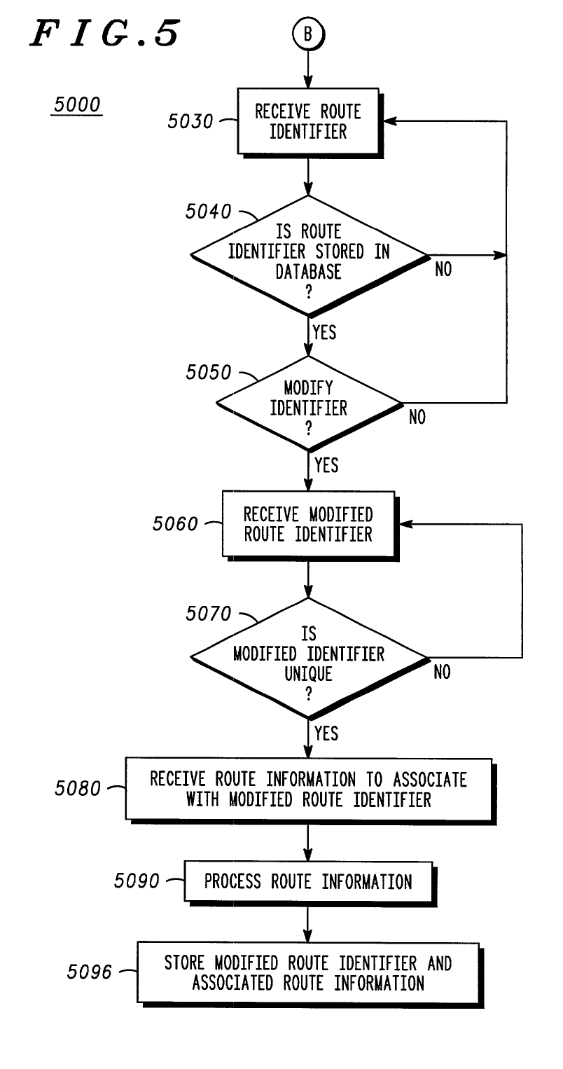

FIG. 5 illustrates one embodiment of a routine for modifying the stored route information in accordance with the present invention at 4000. The routine of FIG. 5 may begin with the input signal being received as illustrated at Block 2010 of FIG. 2. Alternatively, the routine of FIG. 5 may begin after a route identifier has already been stored as illustrated at block 2060.

At Block 5030 of FIG. 5, the route identifier may be received. The identifier may be, for example, a suitable route identifier as described above.

Then, at Block 5040, it may be determined if the route identifier has been stored within system 100. For example, it may be determined if the route identifier has been stored in route database 62. Such a route identifier may have been stored, for example, as indicated at Block 2060 of FIG. 2. If the route identifier has not previously been stored, the routine may return to block 5030 as shown in FIG. 5. Another identifier may then be received.

If the route identifier has been stored, a decision may be made to modify the route identifier at block 5050. If the route identifier will not be modified, the routine may return to block 5030 as shown in FIG. 5. Another identifier may then be received. If the route identifier will be modified, a modified route identifier is received at 5060.

At Block 5070 the uniqueness of the modified route identifier is evaluated. In one embodiment, this evaluation is performed by route application 64. Alternatively, this evaluation is performed by node 16 or by route application 64 on node 16.

If the route identifier received at Block 5070 is not currently in use or is otherwise determined to be unique, the route associated with the modified route identifier may be processed (Block 5090). For example, the points of the route may be processed (e.g., converted to an appropriate format such as a latitude and longitude). Such processing may also include encrypting the modified route identifier and associated route or any other suitable processing. Such processing may also include adding further information to the modified route identifier and its associated route. For example, processing may include completing geographic information related to the points of the route, e.g. adding a zip code or a zip+4 to the addresses associated with one or more points of the route.

Then at block 2095, the modified route identifier and its associated route may be stored in any suitable manner, such as, for example, in a database in communication with communication node 16 or device 12, 32.

Referring now to FIG. 5, an exemplary block diagram of another embodiment of a communication system 200 having the capability to bookmark a route between two or more locations is illustrated.

The communication system 200 generally includes one or more communication devices 201, 202, 203, 204, 205 (five being shown), an electronic network 206, and one or more information sources (e.g., content providers 208, 221 (two being shown) and data and voice markup language servers 209, 251, 253, 257).

The user can access the electronic network 206 by dialing a single direct access telephone number (e.g., a foreign telephone number, a local telephone number, or a toll-free telephone number or PBX) from the communication device 201. The user can also access the electronic network 206 from the communication device 202 via the Internet 220 or WWW, from the communication device 203 via a paging network 211, or from the communication device 205 via a LAN, a WAN, an e-mail connection or in any other similar manner.

As shown in FIG. 5, the electronic network 206 includes a telecommunication network 210 and a communication node 212. The telecommunication network 210 is preferably connected to the communication node 212 via a high-speed data link, such as, for example, a T1 telephone line, a LAN, a WAN or a VOIP network. The telecommunication network 210 preferably includes a PSTN 214 and a carrier network 216. The telecommunication network 210 can also include, for example, international or local exchange networks, cable TV networks, inter-exchange carrier or long distance carrier networks, cellular networks (e.g., mobile switching centers), PBXs, satellite systems, wireless data networks and other switching centers such as conventional or trunked radio systems (not shown), etc. The electronic network 206 can also include additional telecommunication networks, such as, for example, a wireless data network 207.

The PSTN 214 can include various types of communication equipment, such as, for example, ATM networks, Fiber Distributed Data networks (FDDI), T1 lines, cable TV networks, VOIP networks and the like. The carrier network 216 generally includes a telephone switching system or central office 218.

It will be recognized that the carrier network 216 can be any suitable system that can route calls to the communication node 212, and the central office 218 can be any suitable wire-line or wireless switching system.

The communication node 212 is preferably configured to receive and process incoming calls from the carrier network 216 and the Internet 220. The communication node 212 can receive and process pages from the paging network 211 and can also receive and process messages (e.g., e-mails) from the LAN, WAN, wireless data or e-mail system 213.

When a user dials into the electronic network 206 from the communication device 201, the carrier network 216 routes the incoming call from the PSTN 214 to the communication node 212 over one or more telephone lines or trunks. The incoming calls preferably enter the carrier network 216 through one or more “888” or “800” Inward Wide Area Telecommunications Services trunk lines, local exchange or long distance trunk lines. It is also contemplated that the incoming calls can be received from a cable, cellular or VOIP network or any other suitable system.

The communication node 212 answers the incoming call from the carrier network 216 and retrieves an appropriate announcement (e.g., a welcome greeting) from a database, server or browser. The communication node 212 then plays the announcement to the caller. In response to audio inputs from the user, the communication node 212 retrieves information from a destination or database of one or more of the information sources, such as the content providers 208, 221 or the markup language servers 209, 251, 253, 257. After the communication node 212 receives the information, it provides a response to the user based upon the retrieved information.

The communication node 212 can provide various dialog voice personalities (e.g., a female voice, a male voice, etc.), and can implement various grammars (e.g., vocabulary) to detect and respond to the audio inputs from the user. In addition, the communication node 212 can automatically select various speech recognition models (e.g., English, Spanish or English accent models) based upon a user's profile, communication device and/or speech patterns. The communication node 212 can also allow the user to select a particular speech recognition model.

When a user accesses the electronic network 206 from a communication device 201, 202, 203, 204, 205 registered with the system (e.g., home telephone, work telephone, cellular telephone, etc.), the communication node 212 can by-pass a user screening option and automatically identify the user (or the type of communication device) through the use of ANI or CLI. After the communication node 212 verifies the call, the communication node 212 provides a greeting (e.g., “Hi, this is your personal agent, Mya. Welcome Bob. How may I help you?”). The communication node 212 then enters into a dialogue with the user, and the user can select a variety of services offered by the communication node 212.

When the user accesses the electronic network 206 from a communication device not registered with the system (e.g., a payphone, a telephone of a non-user, etc.), the communication node 212 answers the call and prompts the user to enter his or her name and/or a personal identification number (PIN) using voice commands or DTMF signals. The communication node 212 can also utilize speaker verification to identify the particular speech pattern of the user. If the communication node 212 authorizes the user to access the system, the communication node 212 provides a personal greeting to the user (e.g., “Hi, this is your personal agent, Mya. Welcome Ann. How may I help you?”). The communication node 212 then enters into a dialogue with the user, and the user can select various services offered by the communication node 212. If the name and/or PIN of the user cannot be recognized or verified by the communication node 212, the user will be routed to a customer service representative.

Once the user has accessed the communication system 200, the user may implement a wide variety of services and features by using voice commands, such as, for example, voice dialing, voice paging, facsimiles, caller announcements, voice mails, reminders, call forwarding, call recording, content information (e.g., newspapers, etc.), read e-mail, read calendars, read “to-do” lists, banking, e-commerce. The communication system 200 can place outbound calls and pages to business and personal parties or contacts (e.g., friends, clients, business associates, family members, etc.) in response to DTMF signals or voice commands. The calls can be routed through a telephone or electronic network to the selected party and the pagers can be sent to a selected party via a paging system. The communication system 200 can also receive calls routed through a telephone or electronic network.

As shown in FIG. 5, the communication node 212 preferably includes a telephone switch 230, a voice or audio recognition (VRU) client 232, a VRU server 234, a controller or call control unit 236, an Operation and Maintenance Office or a billing server unit 238, a LAN 240, an application server unit 242, a database server unit 244, a gateway server or router firewall server unit 246, a VOIP unit 248, a voice browser 250, a voice markup language server 251, a messaging server 255 and a data markup language server 253. Although the communication node 212 is shown as being constructed with various types of independent and separate units or devices, the communication node 212 can be implemented by one or more integrated circuits, microprocessors, microcontrollers or computers which may be programmed to execute the operations or functions equivalent to those performed by the devices or units shown. It will also be recognized that the communication node 212 can be carried out in the form of hardware components and circuit designs and/or software or computer programs.

The communication node 212 can be located in various geographic locations throughout the world or the United States (e.g., Chicago, Ill.). The communication node 212 can be operated by one or more carriers (e.g., Sprint, Qwest, MCI, etc.) or independent service providers (e.g., Motorola, Inc.).

The communication node 212 can be integrated with the carrier network 216 or can be located remote from the carrier network 216. It is also contemplated that the communication node 212 may be integrated into a communication device, such as, for example, a wire-line or wireless telephone, a radio device, a PC, a PDA, a PIM, etc., and can be programmed to connect or link directly to an information source.

The communication node 212 can also be configured as a standalone system to allow users to dial directly into the communication node 212 via a direct access telephone number. In addition, the communication node 212 may comprise a telephony switch (e.g., a PBX or Centrix unit), an enterprise network or a LAN. In this configuration, the communication system 200 can be implemented to automatically connect a user to the communication node 212 when the user accesses a communication device.

When the telephone switch 230 receives an incoming call from the carrier network 216, the call control unit 236 sets up a connection in the telephone switch 230 to the VRU client 232. The communication node 212 then enters into a dialog with the user regarding various services and functions. The VRU client 232 preferably generates pre-recorded voice announcements and/or messages to prompt the user to provide inputs to the communication node 212 using voice commands or DTMF signals. In response to the inputs from the user, the communication node 212 retrieves information from a destination of one of the information sources and provides outputs to the user.

The telephone switch 230 is preferably connected to the VRU client 232, the VOIP unit 248 and the LAN 240. The telephone switch 230 receives incoming calls from the carrier network 216. The telephone switch 230 also receives incoming calls from the communication device 202 routed over the Internet 220 via the VOIP unit 248. The telephone switch 230 also receives messages and pages from communication devices 203, 205, respectively. The telephone switch 230 is preferably a digital cross-connect switch, Model LNX, available from Excel Switching Corporation, Hyannis, Mass. It will be recognized that the telephone switch 230 can be any suitable switch.

The VRU client 232 is preferably connected to the VRU server 234 and the LAN 240. The VRU client 232 processes voice communications, DTMF signals, pages and messages (e.g., e-mails). Upon receiving voice communications, the VRU client 232 routes the speech communications to the VRU server 234. When the VRU client 232 detects DTMF signals, it sends a command to the call control unit 236. It will be recognized that the VRU client 232 can be integrated with the VRU server 234.

The VRU client 232 preferably comprises a PC, such as, for example, a Windows NT compatible PC, with hardware capable of connecting individual telephone lines directly to the telephone switch 230 or carrier network 216. The VRU client 232 preferably includes a microprocessor, random access memory, read-only memory, a T1 or ISDN interface board, and one or more voice communication processing boards (not shown). The voice communication processing boards are preferably Dialogic boards, Antares Model, available from Dialogic Corporation, Parsippany, N.J. The voice communication boards may include a voice recognition engine having a vocabulary for detecting a speech pattern. The voice recognition engine is preferably a RecServer software package, available from Nuance Communications, Menlo Park, Calif.

The VRU client 232 can also include an echo canceller (not shown) to reduce or cancel TTS or playback echoes transmitted from the PSTN 214 due to hybrid impedance mismatches. The echo canceller is preferably included in an Antares Board Support Package, also available from Dialogic.

The call control unit 236 is preferably connected to the LAN 240, and sets up the telephone switch 230 to connect incoming calls to the VRU client 232. The call control unit 236 also sets up incoming calls or pages to the communication node 212 over the Internet 220 and pages and messages sent from the communication devices 203, 205 via the paging network 211 and email system 213, respectively. The control call unit 236 preferably comprises a PC, such as, for example, a Windows NT compatible PC.

The LAN 240 allows the various components and devices of the communication node 212 to communicate with each other via twisted pair, fiber optic, coaxial cables or the like. The LAN 240 may use Ethernet, Token Ring or other suitable types of protocols. The LAN 240 is preferably a 100 Megabit per second Ethernet switch, available from Cisco Systems, San Jose, Calif., and can comprise any suitable network system. The communication node 212 may include a plurality of LANs.

The VRU server 234 is connected to the VRU client 232 and the LAN 240. The VRU server 234 receives voice communications from the user via the VRU client 232. The VRU server 234 processes the voice communications and compares the voice communications against a vocabulary or grammar stored in the database server unit 244 or a similar memory device. The VRU server 234 provides output signals, representing the result of the voice communications processing, to the LAN 240. The LAN 240 routes the output signal to the call control unit 236, the application server unit 242 and/or the voice browser 250. The communication node 212 then performs a specific function associated with the output signals.

The VRU server 234 preferably includes a TTS unit 252, an automatic speech recognition (ASR) unit 254, and a STT unit 256. The TTS unit 252 receives textual data or information (e.g., e-mail, web pages, documents, files, etc.) from the application server unit 242, the database server unit 244, the call control unit 236, the gateway server unit 246, the application server unit 242 and the voice browser 250. The TTS unit 252 processes the textual data and converts the data to voice data or information.

The TTS unit 252 can provide data to the VRU client 232, which reads or plays the data to the user. For example, when the user requests information (e.g., news updates, stock information, traffic conditions, etc.), the communication node 212 retrieves the desired data (e.g., textual information) from a destination of the one or more of the information sources and converts the data via the TTS unit 252 into a response.

The response is then sent to the VRU client 232. The VRU client 232 processes the response and reads an audio message to the user based upon the response. It is contemplated that the VRU server 234 can read the audio message to the user using human recorded speech or synthesized speech. The TTS unit 252 is preferably a TTS 2000 software package, available from Lernout and Hauspie Speech Product NV, Burlington, Mass.

The ASR unit 254 provides speaker dependent or independent automatic voice recognition of voice communications from the user. It is contemplated that the ASR unit 254 can include speaker dependent voice recognition. The ASR unit 254 processes the voice communications to determine whether a word or a speech pattern matches any of the grammars or vocabulary stored in the database server unit 244 or downloaded from the voice browser 250. When the ASR unit 254 identifies a selected speech pattern of the voice communications, the ASR unit 254 sends an output signal to implement the specific function associated with the recognized speech pattern. The ASR unit 254 is preferably a speaker independent voice recognition software package, RecServer Model, also available from Nuance Communications. It is contemplated that the ASR unit 254 can be any suitable voice recognition unit to detect voice communications.

The STT unit 256 receives voice communications and converts the voice communications to textual information (e.g., a text message). The textual information can be sent or routed to the communication devices 201, 202, 203, 204, 205, the content providers 208, 221, the markup language servers 209, 251, 253, 257, the voice browser 250 and the application server unit 242. The STT unit 256 is preferably a Naturally Speaking software package, available from Dragon Systems, Newton, Mass.

The VOIP unit 248 is preferably connected to the telephone switch 230 and the LAN 240. The VOIP unit 248 allows a user to access the communication node 212 via the Internet 220 or VOIP public network using voice commands. The VOIP unit 248 can receive VOIP protocols (e.g., H.323 protocols) transmitted over the Internet 220 or Intranet, and can convert the VOIP protocols to voice information or data. The voice information can then be read to the user via the VRU client 232. The VOIP unit 248 can also receive voice communications from the user and convert the voice communications to a VOIP protocol that can be transmitted over the Internet 220. The VOIP unit 248 is preferably a Voice Net software package, also available from Dialogic Corporation. It will be recognized that the VOIP unit 248 can be incorporated into a communication device.

The communication node 212 also includes a detection unit 260. The detection unit 260 is preferably a phrase or key word spotter unit, detecting incoming audio inputs or communications or DTMF signals from the user. The detection unit 260 is preferably incorporated into the telephone switch 230, but can be incorporated into the VRU client 232, the carrier network 216 or the VRU server 234. The detection unit 260 is preferably included in a RecServer software package, also available from Nuance Communications.

The detection unit 260 records the audio inputs from the user and compares the audio inputs to the vocabulary or grammar stored in the database server unit 244. The detection unit 260 continuously monitors the user's audio inputs for a key phase or word after the user is connected to the node 212. When the detection unit 260 detects the key phrase or word, the VRU client 232 plays a pre-recorded message to the user. The VRU client 232 then responds to the audio inputs provided by the user.

The billing server unit 238 is preferably connected to the LAN 240. The billing server unit 238 can record data about the use of the communication node 212 by a user (e.g., length of calls, features accessed by the user, etc.). Upon completion of a call by a user, the call control unit 236 sends data to the billing server unit 238. The billing server unit 238 can subsequently process the data in order to prepare customer bills. The billing server unit 238 can use the ANI or CLI of the communication device to properly bill the user. The billing server unit 238 preferably comprises a Windows NT compatible PC.

The gateway server unit 246 is preferably connected to the LAN 240 and the Internet 220. The gateway server unit 246 provides access to the content provider 221 and the voice markup language server 257 via the Internet 220. The gateway server unit 246 allows users to access the communication node 212 from the communication device 202 via the Internet 220. The gateway server unit 246 can function as a firewall to control access to the communication node 212 to authorized users. The gateway server unit 246 is preferably a Cisco Router, also available from Cisco Systems.

The database server unit 244 is preferably connected to the LAN 240. The database server unit 244 preferably includes a plurality of storage areas to store data relating to users, such as, for example, speech vocabularies, dialogs, personalities, user entered data, and other information. Preferably, the database server unit 244 stores a personal file or address book. The personal address book can contain information required for the operation of the communication system 200, including user reference numbers, personal access codes, personal account information, contact's addresses, telephone numbers, etc. The database server unit 244 is preferably a PC, such as, for example, a Windows NT compatible PC.

The application server unit 242 is preferably connected to the LAN 240 and the content provider 208. The application server unit 242 allows the communication node 212 to access information from a destination of the information sources, such as the content providers 208, 221 and the markup language servers 209, 251, 253, 257. For example, the application server unit 242 can retrieve information (e.g., weather reports, stock information, traffic reports, restaurants, flower shops, banks, calendars, “to-do” lists, e-commerce, etc.) from a destination of the information sources. This application server unit 242 may include Starfish Software to provide the address book, calendar and to-do lists, and to allow the user to organize information. The application server unit 242 processes the retrieved information and provides the information to the VRU server 234 and the voice browser 250. The VRU server 234 can provide an audio announcement to the user based upon the information using TTS synthesizing or human recorded voice. The application server unit 242 can also send tasks or requests (e.g., transactional information) received from the user to the information sources (e.g., a request to place an order for a pizza). The application server unit 242 can further receive user inputs from the VRU server 234 based upon a speech recognition output. The application server unit 242 is preferably a PC.

The voice markup language server 251 is preferably connected to the LAN 240. The voice markup language server 251 can include a database, scripts and markup language documents or pages. The voice markup language server 251 is preferably a PC, such as, for example, a Windows NT compatible PC. It will also be recognized that the voice markup language server 251 can be an Internet server (e.g., a Sun Microsystems server).

The messaging server 255 is preferably connected to the LAN 240, the paging network 211, an e-mail system 213 and a short message system (SMS) 290. The messaging server 255 routes pages between the LAN 240 and the paging network 211. The messaging server 255 is preferably a PC, such as, for example, a Windows NT compatible PC. The messaging server 255 can also provide direct storage. It is contemplated that the messaging server 255 can reside externally from the communication node 212.

The voice browser 250 is preferably connected to the LAN 240. The voice browser 250 preferably receives information from the markup language servers 209, 251, 253, 257, the database server unit 244 and the content providers 208, 221. In response to voice commands or DTMF signals, the voice browser 250 generates a content request (e.g., an electronic address) to navigate to a destination of one or more of the information sources. The content request can use at least a portion of a Uniform Resource Locator, an Internet Protocol, a page request, or e-mail.

After the voice browser 250 is connected to an information source, the voice browser 250 preferably uses a Transmission Control Protocol/Internet Protocol connection to pass requests to the information source. The information source responds to the requests, sending at least a portion of the requested information, represented in electronic form, to the voice browser 250. The information can be stored in a database, and can include text content, markup language document or pages, non-text content, dialogs, audio sample data, recognition grammars, etc. The voice browser 250 then parses and interprets the information, further described below. The voice browser 250 can be integrated into the communication devices 201, 202, 203, 204, 205.

As shown in FIG. 5, the content provider 208 is connected to the application server unit 242 of the communication node 212, and the content provider 221 is connected to the gateway server unit 246 of the communication node 212 via the Internet 220. The content providers 208, 221 can store various content information, such as news, banking, commerce, weather, traffic conditions, etc. The content providers 208, 221 can include a server to operate WWW pages or documents in the form of a markup language. The content providers 208, 221 can also include a database, scripts and/or markup language documents or pages. The scripts can include images, audio, grammars, computer programs, etc. The content providers 208, 221 execute suitable server software to send requested information to the voice browser 250.

The voice mail unit 274 is preferably connected to the telephone switch 203 and the LAN 240. The voice mail unit 274 can store voice mail messages from parties trying to send messages to the communication node 212. When a user accesses the electronic network 206, the voice mail unit 274 can notify the user of new and stored messages. The user can access the messages to play, delete, store and forward the messages. When the user accesses a message, the message can be read to the user or can be displayed as textual information on a communication device (e.g., a pager, a SMS 290, or a PDA, etc.). The user can also access and operate external messages or mail systems remote from the electronic network 206.

The FAX server unit 272 is preferably connected to the telephone switch 230 and the LAN 240. The FAX server unit 272 receivers and stores facsimile information sent via the electronic network 206 or the carrier network 216. Users can access the facsimile information to play, store, delete, and forward the information. The facsimile information can be read via the TTS unit 252 or can be displayed as textual information on a suitable communication device. The FAX server unit 272 preferably comprises a PC, such as, for example, a Windows NT compatible PC or a Dialogue Fax Server.

Further information regarding communication system 200 is disclosed in U.S. patent application No. 09/141,485, entitled Telecommunication System and Methods Therefore, filed Aug. 27, 1998, the entire disclosure of which is incorporated herein.

It should be appreciated that the embodiments described above are to be considered in all respects only illustrative and not restrictive. The scope of the invention is indicated by the following claims rather than by the foregoing description. All changes that come within the meaning and range of equivalents are to be embraced within their scope.

I claim:

1. A method of storing and identifying a route, comprising the steps of:
describing a first location;
describing a second location;
defining a route-identifier, wherein the route-identifier identifies a route between the first location and the second location; and
storing the route-identifier.

2. The method of claim 1, further comprising:
retrieving the route-identifier to identify the route.

3. The method of claim 1 further comprising:
requesting information about the route.

4. The method of claim 3 wherein the information is selected from the group consisting of:
traffic information, weather information, travel information and information about other objects on the route.

5. The method of claim 1 further comprising:
receiving information about the route.

6. The method of claim 5 wherein the information is selected from the group consisting of:
traffic information, weather information, travel information and information about other objects on the route.

7. The method of claim 1 wherein the first location is described using measurements selected from the group consisting of:
a latitude and longitude measurement, a cell phone identification, a bookmarked location, an address, a pair of cross-streets, a combined city/state/country identification, a street address; a highway exit number, a highway exit number combined with a city/state identification, a highway road marker number, a highway road marker number combined with a city/state identification, a landmark, a landmark combined with a city/state identification, and an existing route.

8. The method of claim 1 wherein the second location is described using measurements selected from the group consisting of:
a latitude and longitude measurement, a cell phone identification, a bookmarked location, an address, a pair of cross-streets, a combined city/state/country identification, a street address; a highway exit number, a highway exit number combined with a city/state identification, a highway road marker number, a highway road marker number combined with a city/state identification, a landmark, a landmark combined with a city/state identification, and an existing route.

9. The method of claim 1 wherein the route is selected from the group consisting of:
a fastest route, a shortest route, a simplest route, and a scenic route.

10. A method for obtaining information on a route, comprising the steps of:
selecting a starting location;
selecting a destination location; and
defining a route-identifier, wherein the route-identifier identifies a relationship between the starting location and the destination location.

11. The method of claim 10 wherein the relationship between the is a route between the starting location and the destination location, further comprising:
retrieving the route-identifier to identify the route; and
receiving information on the route identified by the route-identifier.

12. The method of claim 10 further comprising:
Selecting at least one intermediate location; and
Identifying the intermediate location with an intermediate-identifier.

13. The method of claim 12 further comprising:
retrieving the route-identifier to identify the route;
providing the intermediate-identifier; and
requesting information on the route based on the relationship of the intermediate identifier to the route-identifier.

14. The method of claim 13 wherein the information is selected from the group consisting of:
traffic information, weather information, travel information and information about other objects.

15. The method of claim 12 further comprising:
retrieving the route-identifier to identify the route;
providing the intermediate-identifier; and
requesting information on the intermediate location based on the relationship of the intermediate identifier to the route-identifier.

16. The method of claim 15 wherein the information is selected from the group consisting of:
traffic information, weather information, travel information and information about other objects.

17. A computer readable medium storing a program for identifying a route, comprising:
computer readable program code that identifies a first location;
computer readable program code that identifies a second location;
computer readable program code that defines a route-identifier, wherein the route-identifier identifies a relationship between the first location and the second location;
computer readable program code that stores the route-identifier; and
computer readable program code that stores the relationship.

18. The program of claim 17, further comprising:
computer readable program code that retrieves the route-identifier.

19. The program of claim 17, further comprising:
computer readable program code that retrieves information based on the route-identifier.

20. The program of claim 17, further comprising:
computer readable program code that identifies an intermediate location with an intermediate-identifier.

21. The program of claim 20, further comprising:
computer readable program code that retrieves the route-identifier to identify the route ;
computer readable program code that retrieves the intermediate-identifier to identify the intermediate location; and
computer readable program code that provides information on the route based on the relationship of the intermediate identifier to the route-identifier.

22. The program of claim 20, further comprising:
computer readable program code that retrieves the route-identifier to identify the route;
computer readable program code that retrieves the intermediate-identifier to identify the intermediate location; and
computer readable program code that provides information on the intermediate location based on the relationship of the intermediate identifier to the route-identifier.

23. A method of identifying a route at a communication node, comprising the steps of:
receiving at the communication node a starting-identifier, wherein the starting-identifier identifies a starting location;
receiving at the communication node a destination-identifier, wherein the destination-identifier identifies a destination location;
defining a route-identifier, wherein the route-identifier comprises the starting-identifier and the destination-identifier; and
storing the route-identifier at the communication node for later retrieval.

24. The method of claim 23 further comprising:
retrieving the route-identifier at a browser to identify the route.

25. The method of claim 23 further comprising:
requesting information about the route wherein the information requested includes the route-identifier.

26. The method of claim 23 further comprising:
transmitting information about the route from the communication node based on the route-identifier.

27. The method of claim 23 wherein the route-identifier comprises a relationship between the starting-identifier and the destination-identifier.

28. The method of claim 27 wherein the relationship between the starting-identifier and the destination-identifier is a route between the starting location and the destination location, further comprising:
retrieving the route-identifier from the communication node to identify the route; and
transmitting information about the route from the communication node based on the route-identifier.

29. The method of claim 23 further comprising:
receiving at the communication node at least one intermediate-identifier, wherein the intermediate-identifier defines an intermediate location.

30. The method of claim 29 further comprising:
retrieving the route-identifier from the communication node to identify the route; and
transmitting information on the route based on the relationship of the intermediate identifier to the route-identifier.

31. The method of claim 29 further comprising:
retrieving the route-identifier from the communication node to identify the route; and
transmitting information on the route based on the relationship of the intermediate identifier to the destination-identifier.
